(19) United States
(12) Patent Application Publication
(10) Pub. No.: US 2024/0125431 A1
(43) Pub. Date: Apr. 18, 2024

(54) Device for Providing Liquid Helium Forced Flow Cooling Fluid

(71) Applicant: Hefei Institutes of Physical Science, CAS, Hefei, Anhui (CN)

(72) Inventors: Xiaofei LU, Hefei, Anhui (CN); Qiyong ZHANG; Anyi CHENG, Hefei, Anhui (CN)

(73) Assignee: Hefei Institutes of Physical Science, CAS, Hefei, Anhui (CN)

(21) Appl. No.: 18/276,803

(22) PCT Filed: Mar. 29, 2023
(86) PCT No.: PCT/CN2023/084602

§ 371 Date: Aug. 10, 2023

(30) Foreign Application Priority Data
Jan. 29, 2022 (CN) 202210110176.7

(51) Int. Cl. F17C 7/02; H01F 6/04

(52) U.S. Cl. CPC F17C 7/02; H01F 6/04; F17C 2205/0111; F17C 2205/0323; F17C 2205/0352; F17C 2221/017; F17C 2223/0161; F17C 2227/0135; F17C 2227/0157; F17C 2227/0339; F17C 2250/0408; F17C 2250/043; F17C 2250/0439; F17C 2270/0527

(57) ABSTRACT

A device for providing a liquid helium forced flow cooling fluid is provided, including a liquid helium vessel system for heat load, a liquid helium vessel system for circulation pump, a liquid helium vessel system for subcooled helium, and a cold box. The liquid helium vessel system for heat load absorbs the heat load of a cryogenic user; the liquid helium vessel system for circulation pump absorbs the heat load of a circulation pump; the liquid helium vessel system for subcooled helium absorbs the heat load of subcooled helium; the device process pipelines and the cold box achieve a pre-cooling process of a cryogenic user, a pre-cooling and liquid storage process of liquid helium vessels, and a pre-cooling and starting-up process of rotating machines, and provide the liquid helium forced flow cooling fluid to accomplish the operations of a cryogenic user. The device for providing a liquid helium forced flow cooling fluid of the present disclosure can effectively reduce the heat load of the liquid helium forced flow cooling device by optimizing the liquid helium forced flow cooling loops and managing the cryogenic heat loads base on the energy level gradient, thereby reducing the investment size and operating cost of a helium cryogenic system.

### FIELD OF THE INVENTION

The present disclosure relates to the technical field of cryogenic and superconducting engineering, and in particular to a device for providing a liquid helium forced flow cooling fluid in the field of the superconducting magnet cryogenic cooling.

### BACKGROUND OF THE INVENTION

Helium is the most difficult gas to be liquefied in nature, and has an extremely low critical temperature with the boiling point of 4.2K at the standard atmospheric pressure. Helium is stable in chemical properties, and has advantages such as high specific heat, high thermal conductivity and low density. Helium is an excellent cryogenic refrigerant, and is widely used in nuclear fusion devices, particle accelerator devices, high-end medical equipment, basic researches and the like.

For cooling the superconducting magnet, the liquid helium forced flow cooling method has many advantages compared with the liquid helium immersion cooling method, such as reduced consumption of liquid helium and reduced risk of overpressure caused by superconductivity loss of the magnet, increased cooling area of the superconducting magnet, as well as providing a more compact system, thereby reducing the construction costs. In addition, the liquid helium fluid can be cooled below 4.2K by utilizing the decompression technology, so that the temperature margin, the magnetic field strength and the operation stability of the superconducting magnet can be further improved. Accordingly, the liquid helium forced flow cooling method used for a large superconducting magnet has been widely used in national scientific engineering.

In order to achieve the forced flow cooling for the superconducting magnet, it is necessary to design and construct a device for providing a liquid helium forced flow cooling fluid, and the device includes, but is not limited to, heat exchangers, liquid helium vessels, a circulation pump, a cold compressor, regulating valves, process pipelines and the like. Heat loads needed to deal with by the device for providing a liquid helium forced flow cooling fluid includes not only the heat load generated by the cryogenic user such as a superconducting magnet, but also the heat load generated by the rotation machines such as the circulation pump and the cold compressor in the device. The existing devices for providing a liquid helium cooling fluid can achieve the forced flow cooling for the superconducting magnet, but the methods to absorb heat loads of the user and the device itself increase the construction cost and operation cost of the helium cryogenic system.

### SUMMARY OF THE INVENTION

In view of this, regarding the problem of liquid helium forced flow cooling heat load, the purpose of the present invention is to propose a device for providing a liquid helium forced flow cooling fluid through optimizing the liquid helium forced flow cooling loop. This device reduces liquid helium forced flow cooling heat load through the energy level gradient management, so as to reduce the investment scale and operation cost of a cryogenic system.

In order to achieve the described objectives, the present disclosure provides a device for providing a liquid helium forced flow cooling fluid, including a liquid helium vessel system for heat load, a liquid helium vessel system for circulation pump, a liquid helium vessel system for subcooled helium, and a cold box, wherein the liquid helium vessel system for heat load, the liquid helium vessel system for circulation pump and the liquid helium vessel system for subcooled helium are all located in the cold box.

Furthermore, the liquid helium vessel system for heat load cools down a helium cooling fluid returned by a cryogenic user to a liquid helium temperature at a positive pressure, so as to achieve a function to absorb a heat load of the cryogenic user; the liquid helium vessel system for circulation pump cools down a helium cooling fluid pressurized and then heated by a circulation pump to the liquid helium temperature at a positive pressure, so as to achieve a function to absorb a heat load of the circulation pump; the liquid helium vessel system for subcooled helium cools down a helium cooling fluid from the liquid helium temperature at a positive pressure to a liquid helium temperature at a negative pressure, so as to achieve a function to absorb a heat load of subcooled helium.

Furthermore, the liquid helium vessel system for heat load includes a liquid helium vessel for heat load, the liquid helium vessel system for circulation pump includes a liquid helium vessel for circulation pump, and the liquid helium vessel system for subcooled helium includes a liquid helium vessel for subcooled helium; a supply pipeline of cryogenic helium fluid is respectively connected to an inlet pipeline of the liquid helium vessel for heat load, an inlet pipeline of the liquid helium vessel for circulation pump and an inlet pipeline of the liquid helium vessel for subcooled helium; an outlet of the liquid helium vessel for subcooled helium is connected to an inlet of a cold compressor; a return pipeline of cryogenic helium fluid is respectively connected to an outlet pipeline of the liquid helium vessel for heat load, an outlet pipeline of the liquid helium vessel for circulation pump and an outlet pipeline of the cold compressor; a supply pipeline of helium cooling fluid for a cryogenic user is connected to an outlet pipeline of the liquid helium vessel system for subcooled helium; and return pipeline of helium cooling fluid for a cryogenic user is connected to an inlet pipeline of the liquid helium vessel system for heat load.

In the present disclosure, the cryogenic user includes, but is not limited to, a superconducting magnet coil, a superconducting magnet coil case, and a cryogenic pump.

Furthermore, the liquid helium vessel system for heat load achieves a function to cool down the helium cooling fluid returned by a cryogenic user to the liquid helium temperature at a positive pressure. The inlet pipeline of the liquid helium vessel system for heat load is connected to an outlet pipeline of the cryogenic user, and is equipped with a regulating valve to control the helium cooling fluid. The liquid helium vessel system for heat load includes a liquid helium vessel, a regulating valve, a heat exchanger, a temperature meter, a pressure meter and a level meter.

Furthermore, the liquid helium vessel system for circulation pump achieves a function to cool down the helium cooling fluid pressurized and heated by the circulation pump to the liquid helium temperature at a positive pressure. An inlet pipeline of the liquid helium vessel system for circulation pump is connected to an outlet pipeline of the liquid helium vessel system for heat load, and is equipped with a circulation pump and a regulating valve to control the pressure and flow of a helium cooling fluid. The liquid helium vessel system for circulation pump includes a liquid helium vessel, a circulation pump, a regulating valve, a heat exchanger, a temperature meter, a pressure meter and a level meter.

Furthermore, the liquid helium vessel system for subcooled helium achieves a function to cool down the helium cooling fluid from the liquid helium temperature at a positive pressure to the liquid helium temperature at a negative pressure. An inlet pipeline of the liquid helium vessel system for subcooled helium is connected to an outlet pipeline of the liquid helium vessel system for circulation pump. The liquid helium vessel system for subcooled helium includes a cold compressor, a liquid helium vessel, a regulating valve, a heat exchanger, a temperature meter, a pressure meter and a level meter.

Furthermore, the device also includes device process pipelines. The device process pipelines and the cold box achieve a function to supply and return a cryogenic helium fluid for the device, supply and return a helium cooling fluid for the cryogenic user, pre-cool and start rotating machines, and realize thermal insulation of the device. The supply pipeline of cryogenic helium fluid is connected to the inlet pipeline of the liquid helium vessel for heat load, the inlet pipeline of the liquid helium vessel for circulation pump and the inlet pipeline of the liquid helium vessel for subcooled helium; the return pipeline of cryogenic helium fluid is connected to the outlet pipeline of the liquid helium vessel for heat load, the outlet pipeline of the liquid helium vessel for circulation pump and the outlet pipeline of the cold compressor. The supply pipeline of helium cooling fluid for a cryogenic user is connected to the outlet pipeline of the liquid helium vessel system for subcooled helium; the return pipeline of helium cooling fluid for a cryogenic user is connected to the inlet pipeline of the liquid helium vessel system for heat load.

Furthermore, the device process pipelines and the cold box are equipped with interfaces via which a helium refrigerator supplies and returns a cryogenic helium fluid, and are equipped with interfaces via which the cryogenic user supplies and returns a helium cooling fluid; the device process pipelines and the cold box are equipped with process pipelines, regulating valves, a heater and a vacuum insulation cold box with thermal shield.

Furthermore, the liquid helium vessel system for heat load includes a liquid helium vessel for heat load and a first heat exchanger located in the liquid helium vessel for heat load; the liquid helium vessel system for circulation pump includes a liquid helium vessel for circulation pump and a second heat exchanger located in the liquid helium vessel for circulation pump; the liquid helium vessel system for subcooled helium includes a liquid helium vessel for subcooled helium and a third heat exchanger located in the liquid helium vessel for subcooled helium.

The helium refrigerator is connected to an inlet of a first device interface, an outlet of the first device interface is divided into four paths, wherein a first path is connected to a supply inlet of the liquid helium vessel for heat load; a second path is connected to a supply inlet of the liquid helium vessel for circulation pump; a third path is connected to a supply inlet of the liquid helium vessel for subcooled helium via a fourth heat exchanger; a fourth path is divided into two branches, wherein the first branch is connected to a third device interface, and the second branch is connected to the liquid helium vessel system for heat load via a heater; the third device interface is used to be connected to an inlet of the cryogenic user.

An return outlet of the liquid helium vessel for subcooled helium is connected to the inlet of the cold compressor via a fourth heat exchanger; an return outlet of the liquid helium vessel for heat load, an return outlet of the liquid helium vessel for circulation pump, and an outlet of the cold compressor are all connected to a second device interface; the second device interface is used to be connected to the helium refrigerator.

An outlet of the cryogenic user is connected to an inlet of the fourth device interface, an outlet of the fourth device interface is divided into two branches, wherein a first branch is connected to the supply inlet of the liquid helium vessel for heat load, and the second branch is connected to an inlet of the first heat exchanger; an outlet of the first heat exchanger is connected to an inlet of the circulation pump, an inlet of the second heat exchanger and an inlet of the third heat exchanger in sequence; an outlet of the third heat exchanger is divided into two branches, wherein a first branch is returned to the liquid helium vessel system for heat load via the heater, and a second branch is connected to the third device interface.

Furthermore, an outlet of the heater is divided into two branches, wherein a first branch is connected to the supply inlet of the liquid helium vessel for heat load, and a second branch is connected to the inlet of the first heat exchanger.

Furthermore, vaporized helium gas from the liquid helium vessel for subcooled helium passes the fourth heat exchanger and the cold compressor, and is mixed with vaporized helium gas from the liquid helium vessel for heat load and vaporized helium gas from the liquid helium vessel for circulation pump, and then returned to the helium refrigerator via the second device interface; the liquid helium forced flow cooling fluid is connected to and then provided to the cryogenic user via the third device interface; the cryogenic user is connected to the device for providing the liquid helium forced flow cooling fluid via the fourth device interface, and returns the liquid helium forced flow cooling fluid to the device.

Further, the working process of the device for providing a liquid helium forced flow cooling fluid includes:

First step, pre-cooling process of a cryogenic user

A cryogenic helium fluid from a helium refrigerator is provided to a cryogenic user via the first device interface and the third device interface; a cryogenic helium fluid of the cryogenic user is returned to the liquid helium vessel for heat load via the fourth device interface; a helium fluid is returned to a helium refrigerator via the second device interface. By means of the described operations, a cryogenic user pre-cooling loop is formed, so that the pre-cooling process of a cryogenic user to liquid helium temperature region is achieved.

Second step, starting-up process of rotating machines

After the pre-cooling process of a cryogenic user is completed, a helium fluid provided by a helium refrigerator after being used to product liquid helium is stored in the liquid helium vessel for heat load, the liquid helium vessel for circulation pump and the liquid helium vessel for subcooled helium via the first device interface, and helium gas in the liquid helium vessel for heat load, the liquid helium vessel for circulation pump and the liquid helium vessel for subcooled helium is returned to a helium refrigerator via the second device interface. By means of the described operations, a circulation pump pre-cooling loop is formed, so that the pre-cooling of the circulation pump is achieved, and the circulation pump is started-up.

Third step, liquid helium forced flow cooling process of the cryogenic user

A liquid helium forced flow cooling loop of a cryogenic user is formed; to meet the liquid helium forced flow cooling operation requirements for a cryogenic user, the liquid helium forced flow cooling fluid is provided by the circulation pump.

The working principle thereof is as follows: a device for providing a liquid helium forced flow cooling fluid cools down the helium cooling fluid warmed up after absorbing a heat load from a cryogenic user, to the liquid helium temperature at a positive pressure through a liquid helium vessel for heat load, then cools down the helium cooling fluid pressurized and heated by a circulation pump, to the liquid helium temperature at a positive pressure, finally, a helium cooling fluid with the liquid helium temperature at a positive pressure is cooled down to the liquid helium temperature at a negative pressure through a liquid helium vessel for subcooled helium, so as to achieve the function of providing a liquid helium forced flow cooling fluid for a cryogenic user.

The present disclosure has the following beneficial effects:

The components used in the device for providing a liquid helium forced flow cooling fluid of the present disclosure are available. According to the heat load characteristics against by the device for providing a liquid helium forced flow cooling fluid, the liquid helium forced flow cooling cycle is optimized to realize the management of the heat load based on the category and the temperature area, so as to effectively reduce the loss of effective energy of the device, thereby reducing the investment cost and operation cost of the helium cryogenic system.

### BRIEF DESCRIPTION OF THE DRAWINGS

In order to describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in this art may still derive other drawings from these accompanying drawings without creative efforts.

FIG. 1 is a process flow diagram of the present disclosure.

In the figures, J1—first device interface, J2—second device interface, J3—third device interface, J4—fourth device interface, CB—cold box, LHe1—liquid helium vessel for heat load, LHe2—liquid helium vessel for circulation pump, LHe3—liquid helium vessel for subcooled helium, HX1—first heat exchanger, HX2—second heat exchanger, HX3—third heat exchanger, HX4—fourth heat exchanger, H—heater, V1—first regulating valve, V2—second regulating valve, V3—third regulating valve, V4—first bypass regulating valve, V5—fifth regulating valve, V6—second bypass regulating valve, V7—seventh regulating valve, V8—eighth regulating valve, V_{S1}—ninth regulating valve, V_{S2}—tenth regulating valve, V_{S3}—eleventh regulating valve, V_{S4}—twelfth regulating valve, V_{G1}—thirteenth regulating valve, V_{G2}—fourteenth regulating valve, V_{G3}—fifteenth regulating valve, V_{C1}—sixteenth regulating valve, V_{C2}—seventeenth regulating valve, P11—first pressure meter, P12—second pressure meter, P13—third pressure meter, P21—fourth pressure meter, P22—fifth pressure meter, P31—sixth pressure meter, P32—seventh pressure meter, T11—first temperature meter, T12—second temperature meter, T13—third temperature meter, T21—fourth temperature meter, T22—fifth temperature meter, T23—sixth temperature meter, T31—seventh temperature meter, T32—eighthther temperature meter, L11—first level meter, L21—second level meter, L31—third liquid level meter, F—flow meter, CP—circulation pump, CC—cold compressor.

### DETAILED DESCRIPTION OF THE EMBODIMENTS

In order to make the objectives, technical solutions, and advantages of the embodiments of the present disclosure clearer, the following further describes the technical solutions of the present disclosure in detail with reference to the embodiments of the present disclosure and the accompanying drawings of the embodiments of the present disclosure. However, the described embodiments are a part rather than all of the embodiments of the present disclosure. Based on the embodiments of the present disclosure, other embodiments that are not involved in inventive work by those skilled in this art all belong to the scope of the present disclosure.

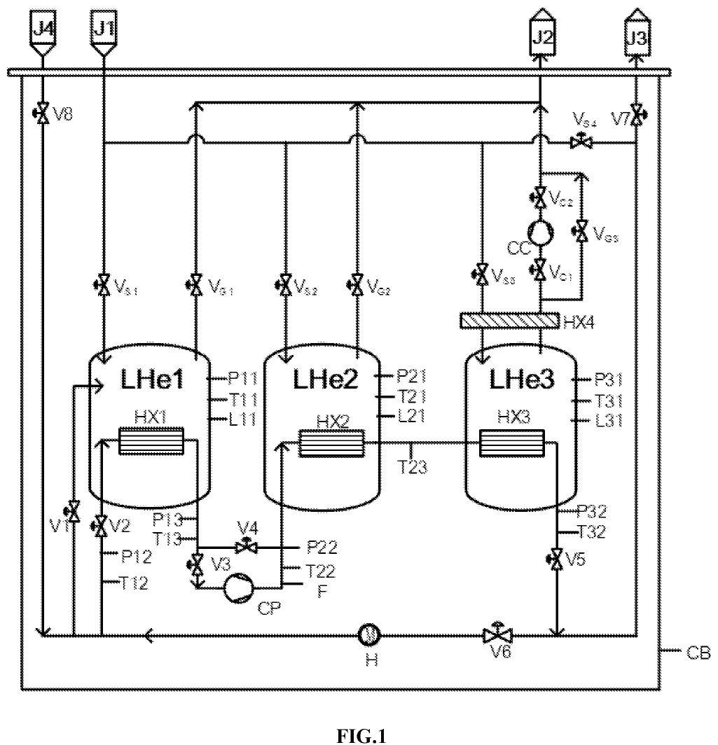

As shown in FIG. 1, a device for providing a liquid helium forced flow cooling fluid is disclosed, and the specific composition thereof includes: a liquid helium vessel system for heat load, a liquid helium vessel system for circulation pump, a liquid helium vessel system for subcooled helium, device process pipelines and a cold box CB. The cold box CB is a shell of the device for providing a liquid helium forced flow cooling fluid, and the liquid helium vessel system for heat load, the liquid helium vessel system for circulation pump and the liquid helium vessel system for subcooled helium are all located inside the cold box CB.

Specifically, a device for providing a liquid helium forced flow cooling fluid includes the following embodiments (taking a case in which the temperature of the liquid helium vessel system for heat load and the liquid helium system for circulation pump is 4.6 K and the temperature of the liquid helium vessel system for subcooled helium is 3.8 K as an example):

The components used in the device are as follows. Referring to FIG. 1, a helium refrigerator is connected to the device for providing a liquid helium forced flow cooling fluid via a first device interface J1. The helium refrigerator is connected to an inlet of the first device interface J1, an outlet of the first device interface J1 is divided into four branches, wherein the first branch is connected to a supply inlet of the liquid helium vessel for heat load LHe1 via a ninth regulating valve V_{S1}; the second branch is connected to a supply inlet of the liquid helium vessel for circulation pump LHe2 via a tenth regulating valve V_{S2}; the third branch is connected to a supply inlet of the liquid helium vessel for subcooled helium LHe3 via an eleventh regulating valve V_{S3} and a fourth heat exchanger HX4 in sequence; the fourth branch is divided into two branches via a twelfth regulating valve V_{S4}, wherein the first branch is connected to a seventh regulating valve V7 and a third device interface J3 in sequence via a cryogenic user supply pipeline to provide liquid helium for a liquid helium vessel and a cryogenic user with a pre-cooled helium fluid, and the second branch is connected to a second bypass regulating valve V6 and a heater H in sequence. A return outlet of the liquid helium vessel for heat load LHe1 is connected to a second device interface J2 via a thirteenth regulating valve V_{G1}, a return outlet of the liquid helium vessel for circulation pump LHe2 is connected to the second device interface J2 via a fourteenth regulating valve V_{G2}, and a return outlet of the liquid helium vessel for subcooled helium LHe3 is connected to a sixteenth regulating valve V_{C1}, a cold compressor CC, a seventeenth regulating valve V_{C2} and the second device interface J2 in sequence via the fourth heat exchanger HX4. The second device interface J2 returns to a helium refrigerator.

The vaporized helium gas from the liquid helium vessel for heat load LH1 passes a thirteenth regulating valve V_{G1} and then returns to a helium refrigerator via a second device interface J2. The vaporized helium gas from the liquid helium vessel for circulation pump LHe2 passes a fourteenth regulating valve V_{G2} and then returns to a helium refrigerator via a second device interface J2. The vaporized helium gas from the liquid helium vessel for subcooled helium LHe3 passes a fourth heat exchanger HX4 and is divided into two branches, the first branch passes a fifteenth regulating valve V_{G3} and then returns to a helium refrigerator via a second device interface J2, and the second branch passes a sixteenth regulating valve V_{C1}, a cold compressor CC and a seventeenth regulating valve V_{C2} in sequence and returns to a helium refrigerator via a second device interface J2. The liquid helium forced flow cooling fluid provided by the device is connected to an inlet of a cryogenic user via a seventh regulating valve V7 and a third device interface J3 to provide the liquid helium forced flow cooling fluid for a cryogenic user; a cryogenic user is connected to the device for providing a liquid helium forced flow cooling fluid via a fourth device interface J4, and then returns the helium cooling fluid to the device for providing a liquid helium forced flow cooling fluid via an eighth regulating valve V8.

A first heat exchanger HX1 is located in the liquid helium vessel for heat load LHe1, and a first pressure meter P11, a first temperature meter T11 and a first level meter L11 are equipped in the liquid helium vessel for heat load LHe1. A second heat exchanger HX2 is located in the liquid helium vessel for circulation pump LHe2, and a fourth pressure meter P21, a fourth temperature meter T21 and a second level meter L21 are equipped in the liquid helium vessel for circulation pump LHe2. A third heat exchanger HX3 is located in the liquid helium vessel for subcooled helium LHe3, a sixth pressure meter P31, a seventh temperature meter T31 and a third level meter L31 are equipped in the liquid helium vessel for subcooled helium LHe3.

An outlet of a cryogenic user is connected to a fourth device interface J4 and a eighth regulating valve V8 in sequence, wherein an outlet of a eighth regulating valve V8 is divided into two branches, wherein the first branch is connected to the supply inlet of the liquid helium vessel for heat load LHe1 via a first regulating valve V1, and the second branch is connected to an inlet of the first heat exchanger HX1 via a second regulating valve V2. An outlet of the heater H is divided into two branches, wherein the first branch is combined with a pipeline of the first branch of the outlet of the eighth regulating valve V8 and then is connected to a first regulating valve V1 and the supply inlet of the liquid helium vessel for heat load LH1 in sequence, and the second branch is combined with a pipeline of the second branch of the outlet of a eighth regulating valve V8 and then is connected to a second regulating valve V2 and the inlet of a first heat exchanger HX1 in sequence. The second branch of the outlet of the heater H is combined with the pipeline of the second branch of the outlet of a eighth regulating valve V8, and then is connected to a second regulating valve V2 via a first pipeline, and a second temperature meter T12 and a second pressure meter P12 are equipped on the first pipeline.

The liquid helium vessel system for heat load achieves the function to cool down the helium cooling fluid returned by a cryogenic user to 4.6K. An input pipeline of the liquid helium vessel system for heat load is connected to the outlet of a eighth regulating valve V8 and the outlet of the heater H via a second regulating valve V2, and is equipped with a second temperature meter T12 and a second pressure meter P12. An output pipeline of the liquid helium vessel system for heat load is connected to an inlet of a circulation pump CP via a third regulating valve V3, and is equipped with a third temperature meter T13 and a third pressure temperature meter P13. The liquid helium vessel system for heat load is equipped with the liquid helium vessel for heat load LHe1 and a first temperature meter T11, a first pressure meter P11 and a first level meter L11. The supply inlet of the liquid helium vessel for heat load LHe1 is connected to an outlet of a ninth regulating valve V_{S1} and an outlet of a first regulating valve V1, and the return outlet of the liquid helium vessel for heat load LHe1 is connected to an inlet of a thirteenth regulating valve V_{G1}. The liquid helium vessel system for heat load is equipped with a first heat exchanger HX1, the inlet of a first heat exchanger HX1 is connected to an outlet of a second regulating valve V2, and an outlet of a first heat exchanger HX1 is connected to an inlet of a third regulating valve V3. An outlet of a third regulating valve V3 is connected to a circulation pump CP, a second heat exchanger HX2 and a third heat exchanger HX3 in sequence.

The liquid helium vessel system for circulation pump achieves the function to cool down the helium cooling fluid pressurized and then heated by a circulation pump to 4.6 K. An input pipeline of the liquid helium vessel system for circulation pump is connected to the outlet of a third regulating valve V3 via a circulation pump CP, and is equipped with a flow meter F, a fifth temperature meter T22 and a fifth pressure meter P22. An output pipeline of the liquid helium vessel system for circulation pump is connected to an inlet of a third heat exchanger HX3, and is equipped with a sixth temperature meter T23. The circulation pump CP is equipped with a first bypass regulating valve V4. The liquid helium vessel system for circulation pump is equipped with the liquid helium vessel for circulation pump LHe2, a fourth temperature meter T21, a fourth pressure meter P21 and a second level meter L21. A supply inlet of the liquid helium vessel for circulation pump LHe2 is connected to an outlet of the tenth regulating valve V_{S2}, and a return outlet of the liquid helium vessel for circulation pump LHe2 is connected to an inlet of a fourteenth regulating valve V_{G2}. The liquid helium vessel system for circulation pump is equipped with a second heat exchanger HX2, an inlet of the second heat exchanger HX2 is connected to an outlet of a circulation pump CP, and an outlet of a second heat exchanger HX2 is connected to an inlet of a third heat exchanger HX3.

The liquid helium vessel system for subcooled helium achieves the function to cool down the liquid helium cooling fluid from 4.6 K to 3.8 K. The liquid helium vessel system for subcooled helium is equipped with a third heat exchanger HX3, an inlet of the third heat exchanger HX3 is connected to an outlet of a second heat exchanger HX2, and an outlet of a third heat exchanger HX3 is connected to an inlet of a fifth regulating valve V5, and is equipped with an eighth temperature meter T32 and a seventh pressure meter P32. An outlet of a fifth regulating valve V5 is divided into two branches, the first branch is connected to a seventh regulating valve V7 and a third device interface J3 in sequence, and the second branch is connected to a second bypass regulating valve V6 and a heater H. The liquid helium vessel system for subcooled helium is equipped with the liquid helium vessel for subcooled helium LHe3, a seventh temperature meter T31, a sixth pressure meter P31 and a third level meter L31. The supply inlet of the liquid helium vessel for subcooled helium LHe3 is connected to an outlet of a eleventh regulating valve V_{S3} via a fourth heat exchanger HX4, and an outlet of the liquid helium vessel for subcooled helium LHe3 is connected to an inlet of a fifteenth regulating valve V_{G3} via the fourth heat exchanger HX4. The liquid helium vessel system for subcooled helium is equipped with a cold compressor CC, an inlet of a cold compressor CC is connected to an inlet of a fifteenth regulating valve V_{G3} via a sixteenth regulating valve V_{C1}, and an outlet of a cold compressor CC is connected to an outlet of a fifteenth regulating valve V_{G3} via a seventeenth regulating valve V_{C2}. The liquid helium vessel system for subcooled helium is equipped with a second bypass regulating valve V6 and a heater H, an inlet of a second bypass regulating valve V6 is connected to an outlet of a fifth regulating valve V5, and an outlet of a second bypass regulating valve V6 is connected to an inlet of a heater H.

The working process of the present system is as follows:

Taking a case in which the temperature of each of the liquid helium vessel system for heat load and the circulation pump is 4.6 K and the temperature of the liquid helium vessel system for subcooled helium is 3.8 K as an example, the specific process of the device for providing a liquid helium forced flow cooling fluid is as follows:

First step, pre-cooling process of a cryogenic user

The twelfth regulating valve V_{S4} and the seventh regulating valve V7 are opened and the cryogenic helium fluid of the helium refrigerant is provided to the cryogenic user via the first device interface J1 and the third device interface J3 is sequence; the eighth regulating valve V8 and the first regulating valve V1 are opened, and the cryogenic helium fluid of the cryogenic user is returned to the liquid helium vessel for heat load LHe1 via the fourth device interface J4; the thirteenth regulating valve V_{G1} is opened, and the helium fluid is returned to the helium refrigerant via the second device interface J2. By means of the described operations, the cryogenic user pre-cooling loop is formed, so that the pre-cooling process of the cryogenic user to the liquid helium temperature region is achieved.

Second step, starting-up process of rotating machines After the pre-cooling process of the cryogenic user is completed, the ninth regulating valve V_{S1}, the tenth regulating valve V_{S2}, the eleventh regulating valve V_{S3}, the thirteenth regulating valve V_{G1}, the fourteenth regulating valve V_{G2} and the fifteenth regulating valve V_{G3} are opened. The helium fluid provided by the helium refrigerator after being used to product liquid helium is stored in the liquid helium vessel for heat load LHe1, the liquid helium vessel for circulation pump LHe2 and the liquid helium vessel for subcooled helium LHe3 via the first device interface J1, and the helium gas in all the liquid helium vessels is returned to the helium refrigerator via the second device interface J2. When the first level meter L11, the second level meter L21 and the third level meter L31 reaching the set value, the second regulating valve V2, the third regulating valve V3, the first bypass regulating valve V4, the fifth regulating valve V5 and the second bypass regulating valve V6 are opened. By means of the described operations, a circulation pump pre-cooling loop is formed, so that the pre-cooling process of the circulation pump is achieved, the first bypass regulating valve V4 is closed and the circulation pump is started gradually. In addition, the sixteenth regulating valve V_{C1} and the seventeenth regulating valve V_{C2} are opened, and pre-cooling and starting-up process of the cold compressor are achieved by gradually closing the fifteenth regulating valve V_{G3}.

Third step, liquid helium forced flow cooling process of the cryogenic user

The twelfth regulating valve V_{S4}, the first regulating valve V1 and the second bypass regulating valve V6 are closed gradually; the liquid helium forced flow cooling loop of the cryogenic user is formed by means of the second regulating valve V2, the third regulating valve V3, the circulation pump CP, the fifth regulating valve V5, the seventh regulating valve V7 and the eighth regulating valve V8; and the operation requirement of the liquid helium forced flow cooling for the cryogenic user is satisfied by the liquid helium forced flow method provided by liquid helium cooling fluid and the circulation pump.

The temperature of the liquid helium vessel system for heat load and the liquid helium vessel system for circulation pump, and the temperature of the liquid helium vessel system for subcooled helium mentioned in the above specific embodiment can be adjusted according to the requirement of the helium refrigerator and the cryogenic user.

In conclusion, it can be seen that the device for providing a liquid helium forced flow cooling fluid provided by the embodiment of the present disclosure optimizes the liquid helium forced flow cooling loops to achieve the management of heat loads based on the temperature area, so as to reduce heat loads of the liquid helium forced flow cooling device, and reduce the investment size and operation cost of the helium cryogenic system.

In conclusion, the foregoing descriptions are merely exemplary embodiments of the present disclosure, but are not intended to limit the scope of the present disclosure. Any modifications, equivalent replacements, improvements and the like made within the spirit and principle of the present disclosure shall belong to the scope of the present disclosure.

What is claimed is:

1. A device for providing a liquid helium forced flow cooling fluid, comprising a liquid helium vessel system for heat load, a liquid helium vessel system for circulation pump, a liquid helium vessel system for subcooled helium, and a cold box, wherein the liquid helium vessel system for heat load, the liquid helium vessel system for circulation pump, and the liquid helium vessel system for subcooled helium are all located in the cold box; the liquid helium vessel system for heat load cools down a helium cooling fluid returned from a cryogenic user to a liquid helium temperature at a positive pressure, so as to achieve a function to absorb a heat load of the cryogenic user; the liquid helium vessel system for circulation pump cools down a helium cooling fluid pressurized and then heated by a circulation pump to the liquid helium temperature at a positive pressure, so as to achieve a function to absorb a heat load of the circulation pump; the liquid helium vessel system for subcooled helium cools down a helium cooling fluid from the liquid helium temperature at a positive pressure to a liquid helium temperature at a negative pressure, so as to achieve a function to absorb a heat load of subcooled helium.

2. The device for providing a liquid helium forced flow cooling fluid according to claim 1, wherein the liquid helium vessel system for heat load comprises a liquid helium vessel for heat load, the liquid helium vessel system for circulation pump comprises a liquid helium vessel for circulation pump, and the liquid helium vessel system for subcooled helium system comprises a liquid helium vessel for subcooled helium;
a supply pipeline of cryogenic helium fluid is respectively connected to an inlet pipeline of the liquid helium vessel for heat load, an inlet pipeline of the liquid helium vessel for circulation pump and an inlet pipeline of the liquid helium vessel for subcooled helium; an outlet of the liquid helium vessel for subcooled helium is connected to an inlet of a cold compressor;
a return pipeline of cryogenic helium fluid is respectively connected to an outlet pipeline of the liquid helium vessel for heat load, an outlet pipeline of the liquid helium vessel for circulation pump and an outlet pipeline of the cold compressor.

3. The device for providing a liquid helium forced flow cooling fluid according to claim 1, wherein the liquid helium vessel system for heat load is equipped with a liquid helium vessel, a regulating valve, a heat exchanger, a temperature meter, a pressure meter, and a level meter; the liquid helium vessel system for circulation pump is equipped with a liquid helium vessel, a circulation pump, a regulating valve, a heat exchanger, a temperature meter, a pressure meter and a level meter; the liquid helium vessel system for subcooled helium is equipped with a liquid helium vessel, a cold compressor, a regulating valve, a heat exchanger, a pressure meter, a temperature meter and a level meter.

4. The device for providing a liquid helium forced flow cooling fluid according to claim 3, wherein the cold compressor is able to be set outside of the device, and replaced by a normal temperature decompression pump, so as to achieve a function to cool down the liquid helium temperature at a positive pressure to the liquid helium temperature at a negative pressure.

5. The device for providing a liquid helium forced flow cooling fluid according to claim 1, further comprising device process pipelines, wherein the device process pipelines and the cold box achieve a pre-cooling process of the cryogenic user, a pre-cooling and liquid storage process of a liquid helium vessel, and a pre-cooling and starting-up process of rotating machines, and provide the liquid helium forced flow cooling fluid for operation of the cryogenic user; the device process pipelines and the cold box are equipped with process pipelines, regulating valves, a heater and a vacuum insulation cold box with thermal shield.

6. The device for providing a liquid helium forced flow cooling fluid according to claim 1, wherein the liquid helium vessel system for heat load comprises a liquid helium vessel for heat load (LHe1) and a first heat exchanger (HX1) located in the liquid helium vessel for heat load (LHe1); the liquid helium vessel system for circulation pump comprises a liquid helium vessel for circulation pump (LHe2) and a second heat exchanger (HX2) located in the liquid helium vessel for circulation pump (LHe2); the liquid helium vessel system for subcooled helium comprises a liquid helium vessel for subcooled helium (LHe3) and a third heat exchanger (HX3) located in the liquid helium vessel for subcooled helium (LHe3);
a helium refrigerator is connected to an inlet of a first device interface (J1), an outlet of the first device interface (J1) is divided into four paths, wherein a first path is connected to a supply inlet of the liquid helium vessel for heat load (LHe1); a second path is connected to a supply inlet of the liquid helium vessel for circulation pump (LHe2); a third path is connected to a supply inlet of the liquid helium vessel for subcooled helium (LHe3) via a fourth heat exchanger (HX4); a fourth path is divided into two branches, wherein a first branch is connected to a third device interface (J3), and a second branch is connected to the liquid helium vessel system for heat load via a heater (H); the third device interface (J3) is used to be connected to an inlet of the cryogenic user;
a return outlet of the liquid helium vessel for subcooled helium (LHe3) is connected to an inlet of a cold compressor (CC) via the fourth heat exchanger (HX4); a return outlet of the liquid helium vessel for heat load (LHe1), a return outlet of the liquid helium vessel for circulation pump (LHe2), and an outlet of the cold compressor (CC) are all connected to a second device interface (J2); the second device interface (J2) is used to be connected to the helium refrigerator;
an outlet of the cryogenic user is connected to an inlet of a fourth device interface (J4), an outlet of the fourth device interface (J4) is divided into two branches, wherein a first branch is connected to the supply inlet of the liquid helium vessel for heat load (LHe1), and a second branch is connected to an inlet of the first heat exchanger (HX1); an outlet of the first heat exchanger (HX1) is connected to an inlet of the circulation pump (CP), an inlet of the second heat exchanger (HX2) and an inlet of the third heat exchanger (HX3) in sequence; an outlet of the third heat exchanger (HX3) is divided into two branches, wherein a first branch is returned to the liquid helium vessel system for heat load via the heater (H), and a second branch is connected to the third device interface (J3).

7. The device for providing a liquid helium forced flow cooling fluid according to claim 6, wherein vaporized helium gas from the liquid helium vessel for subcooled helium (LHe3) passes the fourth heat exchanger (HX4) and the cold compressor (CC) and is mixed with vaporized helium gas from the liquid helium vessel for heat load (LHe1) and vaporized helium gas from the liquid helium vessel for circulation pump (LHe2), and then is returned to the helium refrigerator via the second device interface (J2); the liquid helium forced flow cooling fluid is connected to and then provided to the cryogenic user via the third device interface (J3); the cryogenic user is connected to the device for providing a liquid helium forced flow cooling fluid via the fourth device interface (J4), and returns a helium cooling fluid to the device for providing a liquid helium forced flow cooling fluid.
